(19) United States
(12) Patent Application Publication
(10) Pub. No.: US 2026/0359683 A1
(43) Pub. Date: Nov. 12, 2026

(54) ADAPTIVE INFORMATION REGULARIZER

(71) Applicant: Honda Motor Co., Ltd., Tokyo (JP)

(72) Inventors: Ye-ji MUN, Champaign, IL (US); Sangjae BAE, San Jose, CA (US); Faizan M. TARIQ, San Jose, CA (US); David F. ISELE, Sunnyvale, CA (US)

(21) Appl. No.: 19/202,821

(22) Filed: May 8, 2025

(51) Int. Cl. G06N 5/043

(52) U.S. Cl. CPC G06N 5/043

(57) ABSTRACT

According to one aspect, adaptive information regularization may include receiving information associated with an environment and an agent within the environment and generating an action for an ego-agent based on the information associated with the environment and information from a policy. The policy may be trained based on an information regularizer and a training beta value indicative of whether a prediction of another agent's characteristics reflects cooperation or competition with respect to a training goal for the ego-agent.

### BACKGROUND

Generally, competitive games or scenarios may be zero-sum games where players or agents compete against one another to achieve a goal. Cooperative games or scenarios may be games where players work together to achieve a common goal or different goals.

### BRIEF DESCRIPTION

According to one aspect, a system for adaptive information regularization may include a memory and a processor. The memory may store one or more instructions. The processor may execute one or more of the instructions stored on the memory to perform one or more acts, actions, and/or steps. For example, the processor may perform receiving information associated with an environment and an agent within the environment and generating an action for an ego-agent based on the information associated with the environment and information from a policy. The policy may be trained based on an information regularizer and a training beta value indicative of whether a prediction of another agent's characteristics reflects cooperation or competition with respect to a training goal for the ego-agent.

The other agent and the ego-agent may be vehicles. The goal for the ego-agent may be a first location and the goal for the other agent may be a second location. The first location and the second location may be the same location in a competitive scenario. The first location and the second location may be different locations in a cooperative scenario. The policy may be trained based on fully decentralized reinforcement learning. The policy may be trained based on centralized learning. The processor may determine a beta value indicative of whether the other agent is cooperative or competitive with respect to an estimated goal for the other agent and a goal for the ego-agent based on the information associated with the environment and the other agent within the environment. The beta value may be positive for a cooperative scenario and the beta value may be negative for a competitive scenario. The processor or an actuator may implement the generated action for the ego-agent. The generated action may be different between the cooperative scenario and the competitive scenario.

According to one aspect, a system for adaptive information regularization may include a memory and a processor. The memory may store one or more instructions. The processor may execute one or more of the instructions stored on the memory to perform one or more acts, actions, and/or steps. For example, the processor may perform receiving information associated with an environment and an agent within the environment and training a policy to generate an action for an ego-agent based on the information associated with the environment and the other agent within the environment. The policy may be trained based on an information regularizer and a training beta value indicative of whether a prediction of another agent's characteristics reflects cooperation or competition with respect to a training goal for the ego-agent.

The other agent and the ego-agent may be vehicles. The goal for the ego-agent may be a first location and the goal for the other agent may be a second location. The first location and the second location may be the same location in a competitive scenario. The first location and the second location may be different locations in a cooperative scenario.

According to one aspect, a computer-implemented method for adaptive information regularization may include receiving information associated with an environment and an agent within the environment and generating an action for an ego-agent based on the information associated with the environment and information from a policy. The policy may be trained based on an information regularizer and a training beta value indicative of whether a prediction of another agent's characteristics reflects cooperation or competition with respect to a training goal for the ego-agent.

The other agent and the ego-agent may be vehicles. The goal for the ego-agent may be a first location and the goal for the other agent may be a second location. The first location and the second location may be the same location in a competitive scenario. The first location and the second location may be different locations in a cooperative scenario.

### BRIEF DESCRIPTION OF THE DRAWINGS

FIG. 1 is an exemplary component diagram of a system for adaptive information regularization, according to one aspect.

FIG. 2 is an exemplary flow diagram of a computer-implemented method for adaptive information regularization, according to one aspect.

FIG. 3 is an exemplary illustration of a scenario associated with adaptive information regularization, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

An “agent”, as used herein, may be a machine that moves through or manipulates an environment. Exemplary agents may include robots, vehicles, humans, or other self-propelled machines. The agent may be autonomously, semi-autonomously, or manually operated.

According to one aspect, an adaptive information regularized reinforcement learning approach may be implemented to enable an ego-agent to interact with both cooperative agents and/or competitive agents within an operating environment. The system, vehicle, autonomous vehicle, or robot may adopt its information regularization to either share or hide its intention depending on the interactions with one or more other agents. Also, the system may incorporate information regularization to reinforcement learning to deal with both cooperative and competitive interactions. Generally, a system or a robot has no knowledge of whether another agent that it is interacting with is cooperative or competitive. The framework discussed herein enables a system or a robot generalizable to both cooperative or competitive cases with a single unified framework or policy using adaptive information regularization, implemented for the ego-agent, but not necessarily the other agents. Information sharing as implied through agent behavior may be considered. There may be a benefit or advantage to explicitly or implicitly selecting trajectories that hide or share information when interacting with other agents.

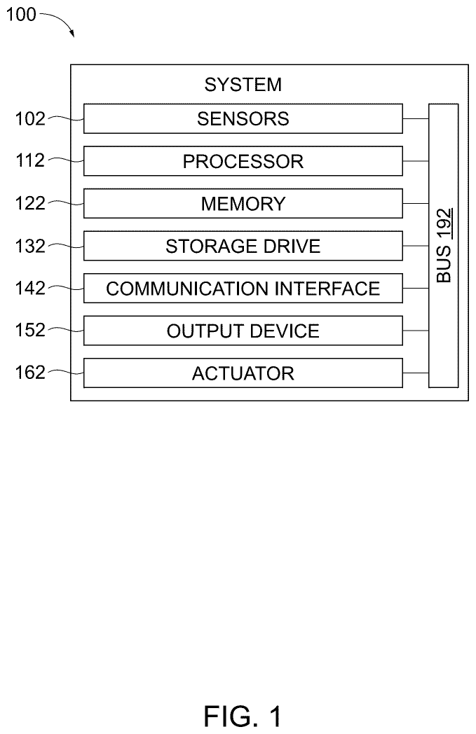

FIG. 1 is an exemplary component diagram of a system 100 for adaptive information regularization, according to one aspect. The system 100 for adaptive information regularization may include one or more sensors 102, a processor 112, a memory 122, a storage drive 132, a communication interface 142, an output device 152, an actuator 162, and a bus 192. The bus 192 may communicatively couple or operatively couple one or more of the respective components and enable computer communication therebetween. The sensors 102 may detect information associated with an environment and an agent within the environment, such as a position, a velocity, an acceleration, a behavior, a traffic maneuver, an activation of a vehicle system, etc. associated with the other agent. Additionally, the sensors 102 may detect information regarding the ego-agent or the system 100 for adaptive information regularization.

As discussed, the system 100 for adaptive information regularization may include the memory 122 and the processor 112. The memory 122 may store one or more instructions. The processor 112 may execute one or more of the instructions stored on the memory 122 to perform one or more acts, actions, and/or steps.

### Partially Observable Stochastic Game

A partially observable stochastic game generalizes a partially observable decision-making process to multiple interacting decision makers. In a Markov game for N agents, each agent i∈{1, . . . , N} may be provided with a local observation of agent oⁱ∈S→Oⁱ to the corresponding global state S and follows a policy πⁱ(aⁱ|oⁱ) that determines an action aⁱ∈Aⁱ given its observation. P(s′|s, a) may be the probability that the state transit from s to s′ given the actions of all agents α∈A¹× . . . A^{N}. According to one aspect, a fully decentralized setting may be considered, where each agent receives a reward rⁱ(s, aⁱ, s′) as a result of its action. The problem may be setup to find a policy that maximizes the discounted expected return

$${R}^{i} = {\sum }_{k = t}^{∞} {r}_{t}^{i} ( {s}_{t} , {a}_{t}^{i} , {s}_{t + 1} ) ,$$

which may be estimated by a value function:

$${π}^{i} = \begin{matrix}arg max \\ {π}^{i}\end{matrix} {V}^{{π}^{i}} ( {s}_{t} )$$

$${V}^{{π}^{i}} ( {s}_{t} ) = {𝔼}_{{{s}_{t + 1}}_{{a}_{t}^{i} \sim {π}_{θ}^{i}}} {\sum }_{k = t}^{∞} {γ}^{t - k} {r}_{t}^{i} ( {s}_{t} , {a}_{t}^{i} , {s}_{t + 1} )$$

where γ is a discount factor.

### Deep Stochastic Policy Gradient

Policy-based methods may be implemented via the processor 112 to learn a policy using an estimation of a policy gradient and a stochastic gradient ascent of this estimated gradient. One example of a gradient estimator is an estimator of the advantage function A^{π}^{_{θ}}:

$${A}_{t}^{{π}_{θ}} = {r}_{t} + γ {V}^{{π}_{θ}} ( {s}_{t + 1} ) - {V}^{{π}_{θ}} ( {s}_{t} )$$

$${∇}_{θ} log {π}_{θ} ( {a}_{t} \vert {s}_{t} ) {A}_{t}^{{π}_{θ}}$$

where π_{θ} is a stochastic policy parameterized by θ. Then, the policy gradient ∇J(θ) using the advantage function may be formulated by the processor 112 as:

$$∇ J ( θ ) = {𝔼}_{a ∼ {π}_{θ}} {∇}_{θ} log {π}_{θ} ( {a}_{t} \vert {s}_{t} ) {A}_{t}^{{π}_{θ}}$$

For monotonic policy improvement and computation efficiency, proximal policy optimization (PPO) may advance the vanilla policy gradient method by taking the largest step possible to improve the performance and clipping the objective:

$$L ( θ ) = {𝔼}_{s , a ∼ {π}_{θ}} [ min ( \frac{{π}_{θ} ( a \vert s )}{{\hat{π}}_{θ} ( a \vert s )} {A}^{{\hat{π}}_{θ}} , clip \frac{{π}_{θ} ( a \vert s )}{{\hat{π}}_{θ} ( a \vert s )} , 1 - ϵ , 1 + ϵ ) {A}^{{\hat{π}}_{θ}} ]$$

where \hat{π}_{θ} is an old policy with old parameters, and ∈ is a hyperparameter. According to one aspect, PPO may be implemented to optimize each agent's policy.

### Regularized Reinforcement Learning (RL)

Deep stochastic policy gradient algorithms may involve a regularization term, such as entropy or a KL divergence term, to encourage exploration or prevent premature convergence to suboptimal policies:

$$π = \begin{matrix}arg max \\ {π}^{i}\end{matrix} [ {V}^{π} ( {s}_{t} ) + λ {𝔻}^{π} ]$$

where λ is a coefficient of the regularization term [symbol] . This regularizer may be viewed as the bonus reward at each time step:

$${V}^{π} ( s ) + {λ𝔻}^{π} = {𝔼}_{{{s}_{t + 1}}_{{a}_{t} \sim {π}_{θ}}} {\sum }_{k = t}^{∞} {γ}^{t - k} [ {r}_{t} ( {s}_{t} , {a}_{t} , {s}_{t + 1} ) + λ {D}_{t}^{π} ]$$

Then, [symbol] becomes a discounted regularization term while DE is a step-wise regularization. The goal of the deep RL agent may now become to find the policy that maximizes the sum of cumulative expected return and the regularization at each time step.

### Problem Setup

The system 100 for adaptive information regularization may aim to solve a mixed stochastic game where the ego-agent interacts with both cooperative and competitive other agents in multi-goal environments. According to one aspect, the ego-agent may interact with either a cooperative or competitive agent, chosen randomly at the beginning of each episode. The reward condition may depend on which type of other agent is actually present in the game. Thus, to maximize its reward, the ego-agent may infer which agent it is interacting with and decide whether to compete or cooperate.

The ego-agent has its own task goal, and how it accomplishes this goal may vary depending on the other agent it is interacting with. In each episode, an ego-agent's goal g_{ego}∈G may be sampled by the processor 112 from a goal set. The ego-agent knows its own goal along with its observation of the environment x_{ego}=(o_{ego}, g_{ego}), while the other agents have no knowledge of it and may infer it by observing the ego-agent xᵢ=oᵢ. The other agent's reward (r₁ or r₂) encourages competition for the same goal g_{ego} or cooperation towards accomplishing two goals by pursuing another goal gₒₜₕₑᵣ. Thus, without the knowledge of the goal, the other agent may learn to estimate the goal locations of the ego-agent from the observation and help or compete with the task achievement. Depending on the type of other agent, the ego-agent may receive two different types of rewards (

$${r}_{ego}^{1} or {r}_{ego}^{2}$$

) at the end of its episode. While both rewards may motivate the ego-agent to accomplish its goal g_{ego}, the ego-agent policy π_{ego} may learn to estimate whether other agent is cooperative or competitive and choose to either share or hide its goal.

The processor 112 may, according to one aspect, formulate this mixed stochastic game as a fully decentralized multi-agent reinforcement learning problem (MARL). Each agent i∈{ego, 1,2}'s policy

$${π}_{θ}^{i}$$

may be optimized by the processor 112 using PPO and its local advantage

$${A}^{{π}_{θ}^{i}}$$

as follows:

$${A}_{t}^{{π}_{θ}^{i}} = {r}_{t}^{i} + γ {V}^{{π}_{θ}^{i}} ( {x}_{t + 1} ) - {V}^{{π}_{θ}^{i}} ( {x}_{t} ) \qquad ( 1 )$$

$${L}^{i} ( θ ) = {𝔼}_{x , {a}^{i} ∼ {π}_{θ}^{i}} [ min ( \frac{{π}_{θ}^{i} ( {a}^{i} \vert x )}{{\hat{π}}_{θ}^{i} ( {a}^{i} \vert x )} {A}^{{\hat{π}}_{θ}^{i}} , clip \frac{{π}_{θ}^{i} ( {a}^{i} \vert x )}{{\hat{π}}_{θ}^{i} ( {a}^{i} \vert x )} , 1 - ϵ , 1 + ϵ ) {A}^{{\hat{π}}_{θ}^{i}} ] \qquad ( 2 )$$

The local critic parameterized by φ may be trained by the processor 112 to minimize the loss between the estimated value and the target value yⁱ using the clipped technique as follows:

$${y}^{i} = {r}_{t}^{i} + γ {\hat{V}}^{{π}_{θ}^{i}} ( {x}_{t + 1} ) \qquad ( 3 )$$

$${L}^{i} ( ϕ ) = {𝔼}_{x , {a}^{i} ∼ {π}_{θ}^{i}} [ max ( {‖ {V}^{{π}_{θ}^{i}} - {y}^{i} ‖}_{2} , {‖ {\hat{V}}^{{π}_{θ}^{i}} + clip ( {V}^{{π}_{θ}^{i}} - {\hat{V}}^{{π}_{θ}^{i}} , - ω , ω ) - {y}^{i} ‖}_{2} ) ] \qquad ( 4 )$$

where

$${\hat{V}}^{{π}_{θ}^{i}}$$

is the old critic with old parameters, and ω is a hyperparameter.

The system 100 for adaptive information regularization may utilize adaptive information regularized RL to facilitate the ego-agent to interact with both cooperative and competitive other agents. The system 100 for adaptive information regularization may adopt its information regularizer to either share or hide its intention depending on the detected interactions.

However, robots or agents generally have no knowledge whether the other agent that it is interacting with is cooperative or competitive. The system 100 for adaptive information regularization makes the robot generalizable to both cases with a single policy using adaptive information regularization. According to one aspect, this information regularization may be implemented for the ego-agent, but not the other agents. As utilized herein, the superscript ego may be omitted for the simplicity and sake of discussion.

### Training Phase

During a training phase, the processor 112 may receive information associated with an environment and an agent within a training environment. Using this information, the processor 112 may train a policy to generate an action for an ego-agent within the training environment. In other words, the processor 112 may train a policy to generate an action for an ego-agent within the training environment based on the information associated with the training environment and one or more agents within the training environment. According to one aspect, the policy may be trained based on fully decentralized reinforcement learning. Alternatively, the policy may be trained based on centralized learning according to another aspect. According to one aspect, the policy may be trained by another system or remotely, received via the communication interface 142 of the system 100 for adaptive information regularization, and stored on the storage drive 132 for implementation, use, or execution.

### Information Regularizer

The processor 112 may employ conditional mutual information between a goal and an action given observation, I^{π}(A; G|O), as a regularizer in RL. I^{π}(A; G|O) may quantify how easily the goal may be inferred from the actions generated by the policy π, which may be defined as:

I^{π}(A;G|O)=

[symbol]

[D_{KL}[π(a|o,g)|π₀(a|o)]]=

[symbol]

[D_{KL}[π(a|x)|π₀(a|o)]] (5)

where τ is a distribution of observations, actions, and goals under the policy π, and π₀(a|o) is a “base policy” that is equivalent to agent's policy in the absence of knowing which one is the goal: π₀(a|o)=Σ_{g} π(a|o, g). In other words, the base policy may be the action distribution when the potential goals have a uniform distribution. Therefore, a lower I^{π}(A; G|O) may be interpreted as ego-agent's intention hiding behavior to confuse the other agent from recognizing the goal. By contrast, a higher I^{π}(A; G|O) may mean the other agent's action conveys information about a certain goal, which may be a true goal to inform the other agent or a wrong goal to deceive the other agent.

The objective of the agent policy with information regularizer becomes:

$$π = \begin{matrix}arg max \\ π\end{matrix} {V}^{π} ( x ) + β {𝕀}^{π} \qquad ( 6 )$$

$${V}^{π} ( x ) + {λ𝕀}^{π} = {𝔼}_{{{s}_{t + 1}}_{{a}_{t} \sim {π}_{θ}}} {\sum }_{k = t}^{∞} {γ}^{t - k} [ {r}_{t} + β {I}_{t}^{π} ] \qquad ( 7 )$$

where [symbol] may be the discounted regularization term of I^{π}, and β may be the parameter that controls the balance between the rewards and the information regularizer. A higher β weighs tendency to share or hide intentions over task rewards, while a lower β prioritizes the rewards. Furthermore, the sign (e.g., positive or negative) of β determines whether agent takes steps towards a specific goal to share (e.g., positive) or ambiguous, multiple goals to hide (e.g., negative) its intention. This is because the policy may learn to maximize its divergence from the uniform-goal base policy with positive beta while the negative beta promotes the policy distribution to be similar to the base policy.

### Adaptive Information Regularizer

The policy may be trained based on an information regularizer, an objective function, a reward function, and a training beta value indicative of whether a prediction (e.g., made by the ego-agent or the processor 112) of another agent's characteristics reflects cooperation or competition with respect to a training goal for the ego-agent. The information regularizer may regulate or control the sharing of information or mutual information between the ego-agent and other agents within the environment.

The processor 112 may determine a beta value indicative of whether the other agent is cooperative or competitive with respect to an estimated goal for the other agent and a goal for the ego-agent based on the information associated with the environment and the other agent. The beta value may be positive for a cooperative scenario and the beta value may be negative for a competitive scenario. Additionally, the processor 112 may adapt or adjust the beta according to how the ego-agent predicts what type of scenario it is in (e.g., competitive, cooperative, neutral, etc.). Further, the processor 112 may determine a degree of cooperativeness or competitiveness based on the environment information and/or scenario (e.g., a high degree of competitiveness may be determined in a zero-sum game scenario). The processor 112 may use an adaptive β to deal with both the cooperative and competitive agent with a single ego-agent's policy.

Although the system 100 for adaptive information regularization is described herein as an exemplary vehicle (e.g., autonomous vehicle, ego-agent, ego-vehicle, robot, ego-robot, etc.), other scenarios where the ‘other agent’ and ‘ego-agent’ may be a first entity and a second entity rather than vehicles or agents. For example, the ‘other agent’ may be an entity that is capable of owning shares of a stock and the ‘ego-agent’ may be another entity that is also capable of owning shares of the stock. In this way, the agent (e.g., other agent) and the ego-agent may be vehicles, robots, entities, etc.

According to the example where the other agent and the ego-agent are vehicles, a goal for the ego-agent may be a first location and a goal for the other agent may be a second location. In other words, the ego-agent and the other agent may have their own desired destination locations. The destination locations may be the same location in a competitive scenario. Alternatively, the destination locations may be different locations in a cooperative scenario. Further, returning to the example where the ‘other agent’ may be an entity that is capable of owning shares of a stock and the ‘ego-agent’ may be another entity that is also capable of owning shares of the stock, the goal for either the ego-agent or the goal for the other agent may be to obtain shares of the stock, for example. In this way, the goal may be a position, a location, a symbolic position, a virtual position, etc.

### Execution Phase

Similarly, during an execution phase, the processor 112 may receive information associated with an environment and an agent within the environment. The processor 112 may generate an action for an ego-agent based on the information associated with the environment and the other agents from a policy. As discussed herein, the policy may be trained based on an information regularizer and a training beta value indicative of whether a prediction of another agent's characteristics reflects cooperation or competition with respect to a training goal for the ego-agent.

The processor 112, the output device 152, or an actuator 162 may implement the generated action for the ego-agent. The generated action may be different between the cooperative scenario and the competitive scenario. Again, scenarios where the ‘other agent’ and ‘ego-agent’ are merely different entities is contemplated, such as any real-world competitive scenario. For example, the ‘other agent’ may be a first entity as a participant in a game and the ‘ego-agent’ may be a second entity as a second participant in the same game. Further, depending on the situation, the ‘other agent’ and the ‘ego-agent’ may be cooperative and competitive at different times. It may be applied to scenarios like football, where a robot player aims to prevent opponents from predicting its intended movement to create opportunities or clear a path. Similarly, in traffic congestion, an autonomous vehicle may conceal its intended lane change or destination exit from human drivers who might compete to maintain or improve their position on the road.

In this way, the system 100 for adaptive information regularization may facilitate an ego-agent to interact with both cooperative and competitive agents using a single framework, rather than distinct or multiple frameworks. The system 100 for adaptive information regularization may adopt its information regularization to either share or hide its intention depending on detected interactions and incorporates information regularization with reinforcement learning to deal with both cooperative and competitive interactions. The system 100 for adaptive information regularization makes the robot generalizable to both the cooperative scenario and the competitive scenario with a single framework using adaptive information regularization.

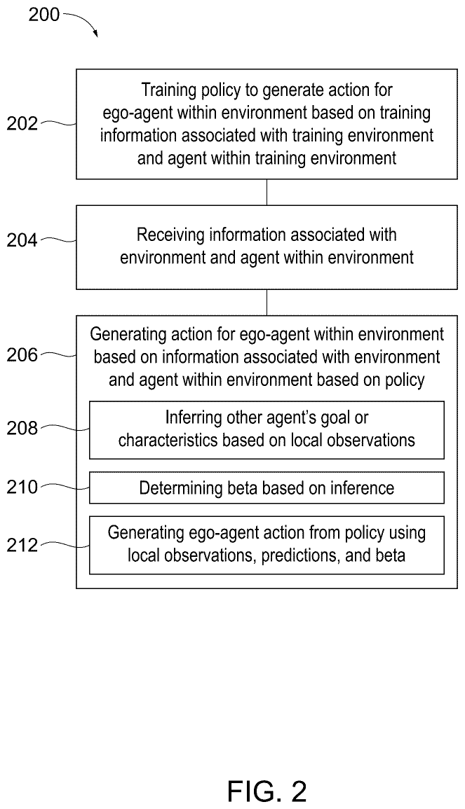

FIG. 2 is an exemplary flow diagram of a computer-implemented method 200 for adaptive information regularization, according to one aspect. The computer-implemented method 200 for adaptive information regularization may include training 202 a policy to generate an action for an ego-agent within a training environment based on training information associated with the training environment and an agent within the training environment, receiving 204 information associated with an execution environment and an agent within the environment, and generating 206 an action for the ego-agent within the execution environment based on the information associated with execution environment and the other agent within the execution environment based on the policy.

According to one aspect, the generating 206 the action for the ego-agent may be achieved by first inferring 208 another agent's goals or characteristics based on local observations (e.g., from sensors 102), calculating 210 the beta based on the inference (e.g., the β as discussed herein), and generating 212 the ego-agent action from the policy using local observations, predictions, and beta.

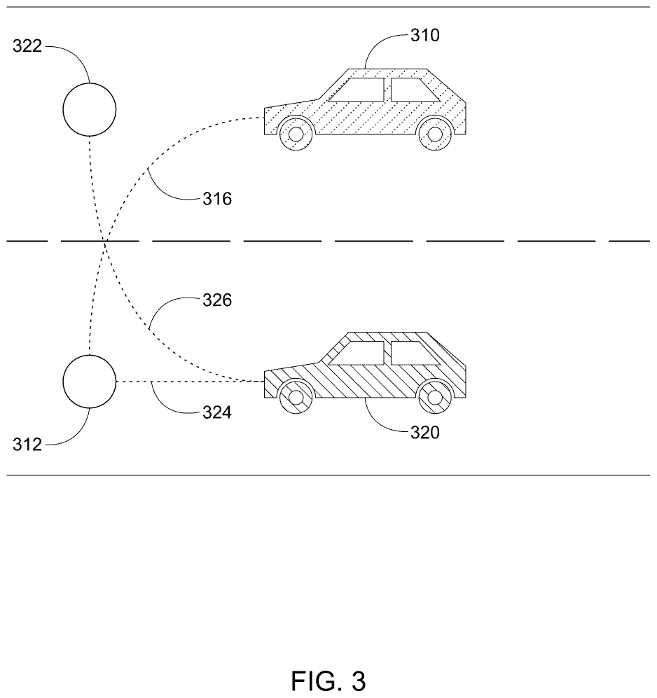

FIG. 3 is an exemplary illustration of a scenario associated with adaptive information regularization, according to one aspect. According to this example, a first vehicle and a second vehicle may be the ego-agent 310 and the other agent 320 within an environment (e.g., the environment may be an operating environment during the execution phase of the adaptive information regularization). There may be a first location 312 and a second location 322 within the operating environment.

According to one aspect, where the ego-agent 310 and the other agent 320 within the operating environment are cooperative with one another, the ego-agent 310 may be attempting to reach the first location 312 or the first goal and the other agent 320 may be attempting to reach the second location 322 or the second goal via trajectory 326. If it is determined by the processor 112 or the system 100 for adaptive information regularization that the ego-agent 310 and the other agent 320 within the operating environment are cooperative with one another, the processor 112 may generate the action for the ego-agent 310 based on the knowledge that respective agents 310, 320 are cooperative and based on the policy trained from the training phase. This action generated by the processor 112 may have a characteristic of clearly indicating to the other agent 320 the trajectory 316 of the ego-agent 310 from the original location to the first location 312. For example, the processor 112 may alter or adjust the trajectory 316 of the ego-agent 310 to be a direct path, enable or activate the use of a turn signal, etc. In this way, the intention of the ego-agent 310 may be implicitly or explicitly shared with the other agent 320.

Conversely, according to another aspect, where the ego-agent 310 and the other agent 320 within the operating environment are competitive with one another, the ego-agent 310 may be attempting to reach the first location 312 or the first goal and the other agent 320 may be attempting to reach the same first location 312. If it is determined by the processor 112 or the system 100 for adaptive information regularization that the ego-agent 310 and the other agent 320 within the operating environment are competitive with one another, the processor 112 may generate the action for the ego-agent 310 based on the knowledge that respective agents 310, 320 are competitive and based on the policy trained from the training phase. This action generated by the processor 112 may have a characteristic of hiding an intention associated with the trajectory 316 of the ego-agent 310 from the original location to the first location 312 based on a prediction that the ego-agent 310 and the other agent 320 within the operating environment are competitive with one another and/or the other agent 320 is attempting to reach the first location 312 via trajectory 324. For example, the processor 112 may alter or adjust the trajectory 316 of the ego-agent 310 to be not as direct of a path, etc. According to another aspect, the processor 112 may generate the action based on an inference in an attempt to manipulate, confuse, or deceive the other agent 320 (e.g., by indicating that the ego-agent 310 may deviate or actually deviating from the trajectory 316, by adding a random unrelated action into the implementation, etc.). The processor 112 may implement the action utilizing an output device 152 (e.g., which may be a vehicle system, such as a turn signal) or one or more of the actuators 162 to initiate a driving maneuver or other vehicular or robotics operation. In this way, the generated action is completely different between the cooperative scenario and the competitive scenario.

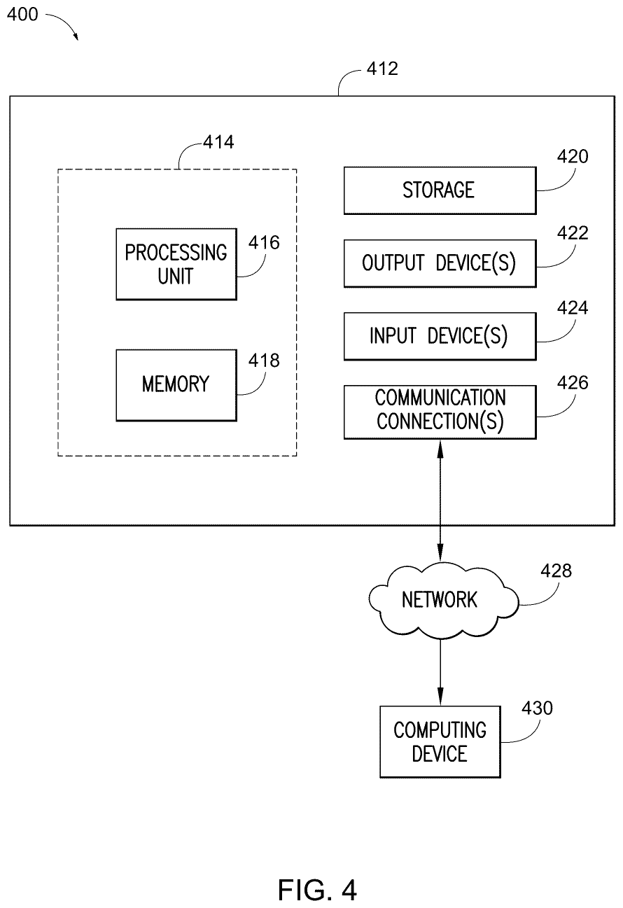

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions is combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. According to one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

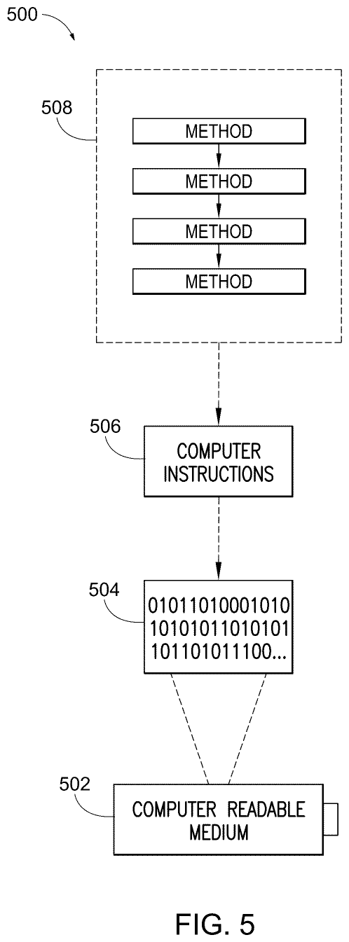

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 200 for adaptive information regularization of FIG. 2. In another aspect, the processor-executable computer instructions 506 may be configured to implement a system, such as the system 100 for adaptive information regularization of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for adaptive information regularization, comprising:
a memory storing one or more instructions; and
a processor executing one or more of the instructions stored on the memory to perform:
receiving information associated with an environment and an agent within the environment; and
generating an action for an ego-agent based on the information associated with the environment and information from a policy,
wherein the policy is trained based on an information regularizer and a training beta value indicative of whether a prediction of another agent's characteristics reflects cooperation or competition with respect to a training goal for the ego-agent.

2. The system for adaptive information regularization of claim 1, wherein the other agent and the ego-agent are vehicles.

3. The system for adaptive information regularization of claim 1, wherein a goal for the ego-agent is a first location and a goal for the other agent is a second location.

4. The system for adaptive information regularization of claim 3, wherein the first location and the second location are the same location in a competitive scenario.

5. The system for adaptive information regularization of claim 3, wherein the first location and the second location are different locations in a cooperative scenario.

6. The system for adaptive information regularization of claim 1, wherein the policy is trained based on fully decentralized reinforcement learning.

7. The system for adaptive information regularization of claim 1, wherein the policy is trained based on centralized learning.

8. The system for adaptive information regularization of claim 1, wherein the processor determines a beta value indicative of whether the other agent is cooperative or competitive with respect to an estimated goal for the other agent and a goal for the ego-agent based on the information associated with the environment and the other agent within the environment.

9. The system for adaptive information regularization of claim 8, wherein the beta value is positive for a cooperative scenario and the beta value is negative for a competitive scenario.

10. The system for adaptive information regularization of claim 9, wherein the processor or an actuator implements the generated action for the ego-agent, and wherein the generated action is different between the cooperative scenario and the competitive scenario.

11. A system for adaptive information regularization, comprising:
a memory storing one or more instructions; and
a processor executing one or more of the instructions stored on the memory to perform:
receiving information associated with an environment and an agent within the environment; and
training a policy to generate an action for an ego-agent based on the information associated with the environment and the other agent within the environment,
wherein the policy is trained based on an information regularizer and a training beta value indicative of whether a prediction of another agent's characteristics reflects cooperation or competition with respect to a training goal for the ego-agent.

12. The system for adaptive information regularization of claim 11, wherein the other agent and the ego-agent are vehicles.

13. The system for adaptive information regularization of claim 11, wherein the goal for the ego-agent is a first location and the goal for the other agent is a second location.

14. The system for adaptive information regularization of claim 13, wherein the first location and the second location are the same location in a competitive scenario.

15. The system for adaptive information regularization of claim 13, wherein the first location and the second location are different locations in a cooperative scenario.

16. A computer-implemented method for adaptive information regularization, comprising:
receiving information associated with an environment and an agent within the environment; and
generating an action for an ego-agent based on the information associated with the environment and information from a policy,
wherein the policy is trained based on an information regularizer and a training beta value indicative of whether a prediction of another agent's characteristics reflects cooperation or competition with respect to a training goal for the ego-agent.

17. The computer-implemented method for adaptive information regularization of claim 16, wherein the other agent and the ego-agent are vehicles.

18. The computer-implemented method for adaptive information regularization of claim 16, wherein the goal for the ego-agent is a first location and the goal for the other agent is a second location.

19. The computer-implemented method for adaptive information regularization of claim 18, wherein the first location and the second location are the same location in a competitive scenario.

20. The computer-implemented method for adaptive information regularization of claim 18, wherein the first location and the second location are different locations in a cooperative scenario.
